(19) United States
(12) Patent Application Publication
(10) Pub. No.: US 2026/0042048 A1
(43) Pub. Date: Feb. 12, 2026

(54) PLEATABLE FILTER MEDIA

(71) Applicant: DelStar Technologies, Inc., Alpharetta, GA (US)

(72) Inventors: Andrew G. Platt, Middletown, DE (US); Lenny Pompeo, Middletown, DE (US); Anthony Platt, Middletown, DE (US); John Cox, Middletown, DE (US)

(21) Appl. No.: 19/289,684

(22) Filed: Aug. 4, 2025

Related U.S. Application Data
(60) Provisional application No. 63/679,719, filed on Aug. 6, 2024.

(51) Int. Cl. B01D 46/52

(52) U.S. Cl. CPC B01D 46/522; B01D 2275/10

(57) ABSTRACT

Nonwoven material, pleated filter media and filters, such as residential and commercial air filters, are provided. A nonwoven material comprises a first fiber layer and a second layer in contact with the first fiber layer. The second layer comprises two or more rows of filaments spaced from each other and extending along at least a portion of the first layer. The rows of filaments provide sufficient support to the filter media that it is capable of holding its shape over time. Thus, a filter media comprising the nonwoven material may be manufactured without a metal mesh, which improves the safety of the filter during handling and facilitates its incineration at the end of its life. In addition, the overall filter may have a lower pressure loss and a higher dust holding capacity because there it does not contain a metal mesh layer blocking air flow through the filter.

### CROSS-REFERENCE TO RELATED APPLICATIONS

This application claims the benefit of U.S. Provisional Application No. 63/679,719, filed Aug. 6, 2024, the complete disclosure of which is incorporated herein by reference for all purposes.

### TECHNICAL FIELD

This description generally relates to self-supporting filter media with improved performance characteristics.

### BACKGROUND

Liquid and gas filters trap contaminants of many different types from the air, water, or others. Air filters, for example, typically include a filtration media comprising fibrous or porous materials which remove solid particulates, such as dust, pollen, mold, and bacteria from the air.

Two main types of air filtration devices include surface filters and depth filters. Surface filters, such as membranes or films, act as a barrier for contaminants that are captured before they enter the media structure. These surface filters typically have a submicron pore size and narrow pore size distribution. Surface filters tend to have relatively high particle capturing efficiency. However, they also have a relatively high pressure drop and a low dust loading capacity. The high pressure drop results in reduced air flow through the filter. The low dust loading capacity significantly reduces the longevity of the filter. As such, surface filters have been used in a limited number of applications in the air filtration industry.

Depth filters are commonly employed in air filtration devices with a moderate to high efficiency, a low pressure drop, and a relatively high dust loading capacity. Depth filters generally employ various kinds of fibers that may be formed into a web or other nonwoven structure having tortuous paths between the fibers through which a gas stream, such as air, is passed. The particulate matter in the gas flowing through the paths in the web is retained on the upstream side of the web, or within the tortuous paths of the web due to the size of the particles relative to the paths' diameters.

Conventional residential and commercial air filters, such as HVAC filters, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values depending on particle sizes within the air stream during testing. E3, E2, and E1 values refer to particulate efficiency at 3-10 microns, 1-3 microns and 0.3 to 1 micron, respectively.

A pleated filter is an air filter that is made from a pliable material, such as polyester, cotton or paper, that is folded to resemble an accordion and housed in a cardboard frame. The folds or pleats provide the filter with more surface area to capture particles. The back side of the pleated filter typically comprises a metal mesh to provide support to the front of the filter, thereby preventing the pleated filter media from collapsing or tearing over time with the high differential pressure generated during use by the accumulation of contaminants. Air flows in one direction from the front side into the metal mesh for proper support. Thus, these filters must typically be inserted into the HVAC system in one direction such that the front of the filter faces the air flow.

Recently, mechanical self-supporting filters have been developed that have pleats capable of holding their shape without a wire mesh backing. Self-supporting pleated filters are considered more environmentally friendly because they do not contain metal and thus are fully incinerable.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Nonwoven material is provided that may be used for a variety of applications, including filter media and filters. The nonwoven material is particularly useful for as filter media in pleated air filters.

In one aspect, a nonwoven material comprises a first fiber layer and a second layer in contact with the first fiber layer. The second fiber layer comprises two or more rows of filaments spaced from each other and extending along at least a portion of the first layer.

In embodiments, the first fiber layer comprises one or more pleats, folds, creases or the like extending in a first direction and the rows of filaments in the second layer extend in a second direction transverse to the first direction. In certain embodiments, the pleats may be considered to extend in a “machine direction (MD)”, and the rows of filaments define an angle of about 80 degrees to about 100 degrees, or about 85 degrees to about 95 degrees, or about 90 degrees, relative to the MD.

In embodiments, the rows of filaments in the second layer are designed to provide support to the first layer. The filaments may comprise filaments, fibers, strands or the like.

In one such embodiment, the nonwoven material may be used, for example, in a pleated filter media. The rows of filaments in the second layer provide sufficient support to the filter media such that it is capable of substantially holding its shape over time despite the high differential pressure generated during use. Thus, the filter media may be manufactured without a metal mesh, which improves the safety of the filter during handling and enables it to be incinerated at the end of its life without having to remove a metal mesh. In addition, the filter has a lower pressure loss and a higher dust holding capacity because there it does not contain a metal mesh layer blocking air flow through the filter.

In embodiments, the first fiber layer comprises a first outer surface and a second outer surface opposite the first surface, wherein the second layer is in contact with the first outer surface. In an exemplary embodiment, the first outer surface is the outflow side of a pleated air filter.

In some embodiments, the overall surface area of the second layer is less than about 50%, or less than about 40%, or less than about 30%, or less than about 25%, or less than about 20% of the overall surface area of the first fiber layer. Reducing the overall surface area of the rows of filaments in the second layer increases air flow therethrough, which reduces pressure loss and increases dust holding capacity.

In an exemplary embodiment, the overall surface area of second layer 30 (i.e., the total surface area of the rows of filaments 32) is between about 50% to about 25%, or between about 40% to about 25% of the overall surface area of first fiber layer 20. Applicant has discovered that this range provides sufficient support to the first layer to maintain pleat height during use, while still allowing sufficient air flow therethrough.

In embodiments, the first fiber layer comprises a first end and a second end opposite the first end. Each of the rows of filaments in the second layer extends substantially continuously from the first end to the second end.

In another embodiment, each of the rows of filaments in the second layer comprise a plurality of discrete portions spaced from each other. Each of the discrete portions extend across a substantial portion of an individual pleat such that the discrete portions support the pleated areas of the first fiber layer. The discrete portions may define gaps between each of the pleats. The discrete portions may be substantially parallel with each other, or they may be staggered relative to each other in a direction transverse to the first direction.

In embodiments, the pleats each define a first end or first inside fold, an outside fold and a second end or second inside fold. In an exemplary embodiment, each of the discrete portions extends substantially continuously from the first end or first inside fold to the second end or second inside fold of one of the pleats.

The rows of filaments in the second layer may have thicknesses that are suitable for the application. In embodiments, the rows of fibers have a thickness of about 0.1 mm to about 5.0 mm, or about 0.2 mm to about 3.0 mm, or about 0.5 mm to about 1.5 mm, or about 1.0 mm. In an exemplary embodiment, the rows of filaments each comprise a single strand of fiber.

The fibers and/or filaments in the first and second layers may have many shapes in cross-section, including without limitation, circular, oval, square, rectangular, kidney bean, dog bone, trilobal, barbell, bowtie, star, Y-shaped, and others. These shapes and/or other conventional shapes may be used with the embodiments to obtain the desired performance characteristics. In such instances, the maximum dimension of the rows of filaments in the second layer may be about 0.1 mm to about 5.0 mm, or about 0.2 mm to about 3.0 mm, or about 0.5 mm to about 1.5 mm, or about 1.0 mm.

In embodiments, the rows of filaments in the second layer are spaced from each other by a distance of about 0.25 mm to about 125 mm, or about 0.5 mm to about 75 mm, or about 13 inches to about 40 mm, or about 25 mm. In some embodiments, the filaments may be spaced from each other by a distance of about 50 mm, or about 60 mm, or about 75 mm.

In embodiments, the second layer comprises additional rows of filaments extending in a second direction transverse to the first direction of filaments in the second row. In an exemplary embodiment, the second direction is substantially perpendicular to the first direction. This creates a crisscross pattern that may provide additional support to a pleated filter media. In an exemplary embodiment, the first rows of filaments extend in the machine direction (MD) and the additional rows of filaments extend in the cross machine direction (CD).

In embodiments, the second layer is bonded to the first fiber layer. In one embodiment, the second layer is thermally bonded to the first fiber layer. In another embodiment, the second layer is printed onto the first fiber layer by, for example, a gravure roll or the like.

The fibers can be manufactured by any suitable method, including, without limitation, thermally bonded, cellulose wet laid, glass wet laid, synthetic wet laid, composite wet laid, meltblown, spunbond or spunlace, bicomponent spunbond, heat-bonded, carded, air-laid, wet-laid, extrusion, co-formed, needlepunched, stitched, hydraulically entangled or combinations thereof. In certain embodiments, the fibers are spunbond or meltblown fibers.

The fibers and filaments in the first and second layers may be artificial or natural. The fibers in the first layer may comprise a different material from the filaments in the second layer, or they may comprise the same material. The rows of filaments in the second layer may comprise recycled material.

Suitable materials for the fibers and filaments in the first and second layers include, but are not limited to, polylactic acid (PLA), polyethylene terephthalate (PET), polypropylene (PP), polyester, coPET, polypropylene, polycaprolactam, polyamides, such as polyamide 6 (PA 6), polyamide 6-6 (PA 6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

In certain embodiments, the fibers in the first layer are monocomponent. In other embodiments, the fibers in the first layer comprise biocomponent fibers having a core and a sheath. In embodiments, the core is eccentric with the sheath. In other embodiments, the core is concentric with the sheath. In embodiments, the core comprises a different material than the sheath.

In an exemplary embodiment, the melting temperature and/or melt flow rate (MFR) of the sheath is within about 15 degrees Celsius, or within about 5 degrees Celsius, of the melting temperature and/or melt flow rate (MFR) of the filaments in the second layer. This allows the filaments in the second layer to thermally bond to the sheaths of the fibers in the first layer.

In another aspect, a self-supporting filter media comprises a first fiber layer comprising one or more pleats extending in a first direction and a second layer in contact with the first layer. The second layer comprises two or more rows of filaments spaced from each other and extending in a second direction transverse to the first direction.

In certain embodiments, the pleats may be considered to extend in a “machine direction (MD)”), and the rows of filaments define an angle of about 80 degrees to about 100 degrees, or about 85 degrees to about 95 degrees, or about 90 degrees, relative to the MD.

In embodiments, the first fiber layer comprises a first outer surface and a second outer surface opposite the first surface, wherein the second layer is in contact with the first outer surface. In an exemplary embodiment, the first outer surface is the outflow side of a pleated filter (i.e., the downstream side of the filter relative to the air flow direction).

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a cross-sectional view of a non-woven material;

FIG. 2 is a cross-sectional view of a pleated filter media;

FIG. 3 is a cross-sectional view of another embodiment of a pleated filter media:

FIGS. 4-9 schematically illustrate different fiber configurations for a non-woven material or filter media;

FIG. 10 is a cross-sectional view of another embodiment of a filter media; and

FIG. 11 is a perspective view of a pleated air filter.

### DETAILED DESCRIPTION OF THE EMBODIMENTS

This description illustrates exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Nonwoven material is provided that may be used for a variety of applications, including but not limited to, filter media and filters, such as liquid filters, gas filters, face masks, CPAP filters, vacuum bags, cabin air filters, HVAC furnace filters, residential and commercial air filters, gas turbine, and compressor air intake filters, pre-filters, panel filters and the like. The nonwoven material is particularly useful as a filter media in self-supporting pleated air filters.

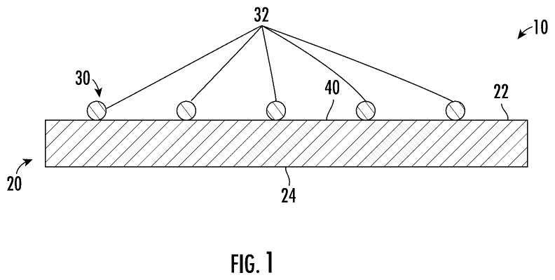

Referring now to FIG. 1, a nonwoven material 10 comprises a first fiber layer 20 and a second layer 30. Second layer 30 comprises at least two rows of filaments 32 In some embodiments, the filaments may be spaced from each other by a distance of about 50 mm, or about 60 mm, or about 75 mm. from each other and extending along first fiber layer 20. The filaments 32 may comprise filaments, fibers, strands or the like. In some embodiments, second layer 30 comprises three or more rows, or four or more rows, or five or more rows depending on the width or length of fiber layer 20 and the distance between each row. In certain embodiments, the rows 32 are spaced substantially equally to each other and in other embodiments, the spacing between rows 32 varies. In embodiments, the rows of filaments 32 are spaced from each other by a distance of about 0.25 mm to about 125 mm, or about 0.5 mm to about 75 mm, or about 13 inches to about 40 mm, or about 25 mm.

In embodiments, first fiber layer 20 comprises a first outer surface 22 and a second outer surface 24 opposite first surface 22 and second layer 30 is in contact with first outer surface 22. In an exemplary embodiment, first outer surface 22 is the outflow side of a pleated air filter (i.e., the downstream side of the filter relative to the air flow direction). In other embodiments, second layer 30 may be in contact with the inflow side of a pleated air filter, or it may be in contact with both surfaces 22, 24 of fiber layer 20.

The term “upstream” is used to denote the side of an air filter from which moving air (e.g. in an HVAC system) impinges on the filter media. The term “downstream” is used to denote the side of an air filter through which air exits the filter media. Pleated filters are often marked (or otherwise designated) by the manufacturer to identify upstream and downstream sides in order that the filter be installed in the proper orientation in an HVAC system; thus, the terms upstream and downstream can serve to differentiate the two sides of a pleated filter even if the filter has not yet been positioned in an HVAC system.

In an exemplary embodiment, the overall surface area of second layer 30 (i.e., the total surface area of the rows of filaments 32) is between about 50% to about 25%, or between about 40% to about 25% of the overall surface area of first fiber layer 20. Applicant has discovered that this range provides sufficient support to the first layer to maintain pleat height during use, while still allowing sufficient air flow therethrough.

In other embodiments, the overall surface area of second layer 30 is less than about 50%, or less than about 40%, or less than about 30%, or less than about 25%, or less than about 20% or less than about 10% of the overall surface area of first fiber layer 20. In an exemplary embodiment, the overall surface area of second layer 30 (i.e., the total surface area of the rows of filaments 32) is between about 50% to about 25%, or between about 40% to about 25% of the overall surface area of first fiber layer 20. Thus, the rows of filaments 32 provide support to first fiber layer 20 while minimizing the amount of material in second layer 30 that would otherwise block air flow through the filter, which reduces the pressure loss across the filter and increases its dust holding capacity.

The rows of filaments 32 in second layer 30 may have thicknesses that are suitable for the application. In embodiments, rows of fibers 32 each have a thickness of about 0.1 mm to about 5.0 mm, or about 0.2 mm to about 3.0 mm, or about 0.5 mm to about 1.5 mm, or about 1.0 mm. In an exemplary embodiment, rows of filaments 32 each comprise a single strand of fiber. The thicknesses are measured with an optical microscope or a scanning electron microscope (SEM).

The fibers and/or filaments in the first and second layers may have many shapes in cross-section, including without limitation, circular, oval, square, rectangular, kidney bean, dog bone, trilobal, barbell, bowtie, star, Y-shaped, and others. These shapes and/or other conventional shapes may be used with the embodiments to obtain the desired performance characteristics. In such instances, the maximum dimension of the rows of filaments 32 in second layer may be about 0.1 mm to about 5.0 mm, or about 0.2 mm to about 3.0 mm, or about 0.5 mm to about 1.5 mm, or about 1.0 mm. In an exemplary embodiment, rows of filaments 32 each comprise a single strand of fiber. The dimensions of the filaments are measured with an optical microscope or a scanning electron microscope (SEM).

The fibers and/or filaments in the first and second layers may be manufactured by any suitable method, including, without limitation, thermally bonded, cellulose wet laid, glass wet laid, synthetic wet laid, composite wet laid, meltblown, spunbond or spunlace, bicomponent spunbond, heat-bonded, carded, air-laid, wet-laid, extrusion, co-formed, needlepunched, stitched, hydraulically entangled or combinations thereof. In certain embodiments, the fibers and/or filaments are spunbond or meltblown fibers.

In embodiments, the second layer is bonded to the first fiber layer. In one embodiment, the second layer is thermally bonded to the first fiber layer. In another embodiment, the second layer is printed onto the first fiber layer by, for example, a gravure roll or the like.

In certain embodiments, first fiber layer 20 comprises a substrate, sheet, layer, film, web, or other media comprising fibers. The nonwoven fiber layer 20 may comprise a structure of individual fibers or threads that are interlaid, interlocked, or bonded together. Nonwoven fabrics may include sheets or web structures bonded together by entangling fiber or filaments (and by perforating films) mechanically, thermally, or chemically. They may be substantially flat, porous sheets that are made directly from separate fibers or molten plastic or plastic film.

The fibers in first fiber layer 20 may be artificial or natural. Suitable materials for the fibers in layer 20 include, but are not limited to, polylactic acid (PLA), polyethylene terephthalate (PET), polypropylene (PP), polyester, coPET, polypropylene, polycaprolactam, polyamides, such as polyamide 6 (PA 6), polyamide 6-6 (PA 6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

The rows of filaments 32 in second fiber layer 30 may be artificial or natural. The filaments 32 may comprise recycled material. Suitable materials for the fibers 32 include, but are not limited to, polylactic acid (PLA), polyethylene terephthalate (PET), polypropylene (PP), polyester, coPET, polypropylene, polycaprolactam, polyamides, such as polyamide 6 (PA 6), polyamide 6-6 (PA 6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

The fibers and filaments stay connected to each other through thermal bonds and chemical bonds (air through or point bonded or ultrasonically bonded), by being entangled with one another, through the use of binding agents, such as adhesives, or the like.

In certain embodiments, the fibers in the first layer are monocomponent. In other embodiments, the fibers in the first layer comprise biocomponent fibers. The bicomponent fibers may comprise any suitable shape, such as core/sheath with a concentric core, core/sheath with an eccentric core, side by side with a solid or a hollow core, side by side with a concentric or an eccentric hollow core, segmented pie with a solid or a hollow core, striped fibers, conductive fibers, island by the sea, mixed fibers, or combinations thereof.

In embodiments, the biocomponent fibers have a core and a sheath. In embodiments, the core is eccentric with the sheath. In other embodiments, the core is concentric with the sheath. In embodiments, the core comprises a different material than the sheath.

In an exemplary embodiment, the melting temperature and/or melt flow rate (MFR) of the sheath component is within about 15 degrees Celsius, or within about 5 degrees Celsius, of the melting temperature and/or melt flow rate (MFR) of the filaments 32 in the second layer 30. This allows the sheath component to be thermally bonded to filaments 32 in second row 30. Suitable materials for the sheath component of the bicomponent fibers include, but are not limited to, polypropylene (PP)/polyethylene (PE), polyethylene terephthalate (PET)/polypropylene (PP), HDPE/PET, PP/PET, CoPET/PET, PLA/PLA, mPP/iPP and the like.

In certain embodiments, the core component comprises a material having a melting point and/or a melt flow rate (MFR) higher than the sheath material. This inhibits the core component from thermally bonding to the filaments 32 in second layer 30. Suitable materials for the core component include, but are not limited to, polyolefins, polyethylene (PE), polypropylene (PP), blends of PP and PE, PBT, PET, PLA, polyamides, and combinations thereof.

In some embodiments, the first fiber layer may comprise a “high loft” nonwoven material comprising spunbond or air through bonded carded nonwoven fibers. As used here in the term “high loft” means that the volume of void space is greater than the volume of the total solid. In air through bonded carded nonwoven fibers, the loftiness of a fiber layer can be controlled by various means known to those of skill in the art. For example, loftiness can be increased by applying less compression force onto the media during bonding. In another example, a high loft nonwoven material can be manufactured with fibers having larger thicknesses, such as thicknesses greater than 3 denier, e.g., 5 denier or greater, 6 denier or greater. In other embodiments, the loftiness may be increased by using eccentric biocomponent fibers.

The fibers and/or filaments in the first and second layers may be staple fibers or continuous fibers. The fibers and/or filaments may be naked (e.g., zero spin finish) or the fibers and/or filaments may include a spin finish. The spin finish may include but is not limited to, lubricants, emulsifiers, antistats, anti-microbial agents, cohesive agents and wetting agents. Other organic liquids, such as alcohols or blends of organic liquids may be added to the spin finish. The spin finish may be applied, for example, during carding of the fibers, during the melt spinning operation, or operation of drawing, crimping, and cutting of the fibers.

The fibers in the first layer 20 may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in the linear mass density of fibers. In some embodiments, the fibers may have a linear density of about 1 denier to about 10 denier. The fibers may be configured as a gradient density media in which the pore size decreases from the upper surface of the filter (upstream) to the lower surface (downstream) or vice versa to increase capture efficiency and dust holding capacity.

In certain embodiments, the first fiber layer 20 may include at least two different fiber thicknesses or linear densities to provide at least two different layers of the filter within the same filter media. In certain embodiments, the first fiber layer 20 may include three or more separate portions or layers with different denier fiber ranges within each portion.

Referring now to FIG. 2, in certain embodiments, first fiber layer 20 may comprise a plurality of pleats, folds or creases 40 extending generally parallel to each other in a first direction along the length (or width) of fiber layer 20. Pleats 40 generally comprise an outside fold 42, and first and second inside folds 44, 46 and may be spaced from each other by any suitable distance. In some embodiments, there is no spacing between pleats 40 as the second inside fold 46 of one pleat is also the first inside fold 44 of an adjacent pleat. In an exemplary embodiment, first fiber layer 20 comprises a pleated filter media 50 for a filter, such as an air filter.

In embodiments, pleats 40 generally extend in a first direction (i.e., the direction generally parallel to each fold and perpendicular to adjacent pleats). As shown, each of the rows of filaments 32 in second fiber layer 30 preferably extend substantially continuously from one end of first fiber layer 20 to the other end. Pleats 40 may be considered to extend in a “machine direction (MD)”, and the rows of filaments in layer 30 extend in a direction that defines an angle of about 80 degrees to about 100 degrees, or about 85 degrees to about 95 degrees, or about 90 degrees, relative to the MD.

The rows of filaments 32 in second fiber layer 30 are designed to provide support to first layer 20. In one embodiment, the rows of filaments 32 in the second layer 30 provide sufficient support to the filter media such that it is capable of holding its shape over time despite the high differential pressure generated during use by the accumulation of contaminants. Thus, the filter media may be manufactured without a metal mesh, which improves the safety of the filter during handling and enables it to be incinerated at the end of its life without having to remove the metal mesh. In addition, the overall filter may have a lower pressure loss and a higher dust holding capacity because there is no metal mesh blocking air flow through the filter.

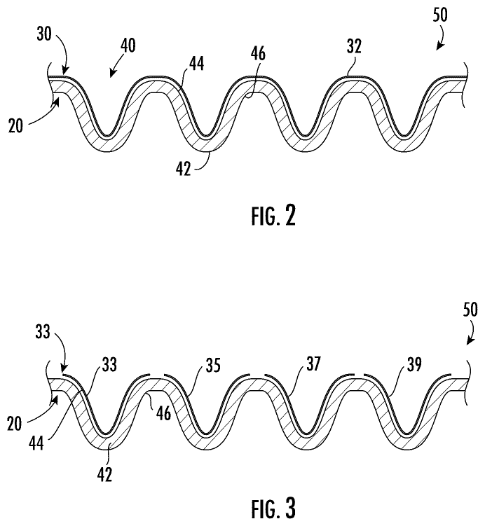

Referring now to FIG. 3, in another embodiment, each of the rows 32 of second layer 30 comprise discrete portions 33, 35, 37, 39 that are spaced from each other. Each discrete portion 33, 35, 37, 39 extends across at least a portion of one of the pleats 40. The discrete portions may, for example, extend from the first inside fold 44 to the second inside fold 46 of each pleat 40. Alternatively, the discrete portions of filaments may extend across only a portion of a pleat, e.g., from a first location between first inside fold 44 and outside fold 42 to a second location between second inside fold 46 and outside fold 42. This ensures that the rows of filaments 32 provide sufficient support to the pleats 40 to allow first layer 20 to substantially hold its shape.

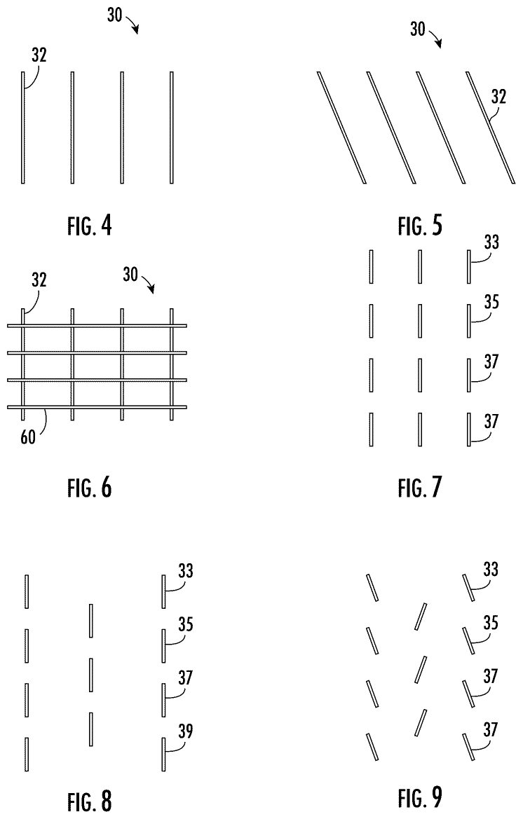

FIGS. 4-9 illustrate alternative patterns of rows 32 in second layer 30. For example, FIG. 4 illustrates that the rows 32 may be substantially parallel to each other and substantially perpendicular to the direction of pleats 40 in first layer 20. FIG. 5 illustrates that the rows 32 may be substantially parallel to each other and form an angle relative to the direction of the pleats 40.

FIG. 6 illustrates an alternative embodiment comprising additional rows 60 of filaments in second layer 30. In this embodiment, the additional rows 60 extend in a direction transverse to rows 32. In some embodiments, rows 60 may be perpendicular to rows 32. In one such embodiment, rows 32 extend in the machine direction and rows 60 extend in a cross-machine direction. In another embodiment, both rows 32 and 60 are substantially perpendicular to each other, but transverse to the MD and the CD, by an angle of about 1 degree to about 15 degrees.

FIG. 7 illustrates an embodiment wherein the rows of filaments 32 in second layer 30 comprise discrete portions 33, 35, 37, 39 that are spaced from each other in the direction of the rows 32. In this embodiment, the rows 32 are substantially parallel to each other and the discrete portions of each row 32 are aligned with the discrete portions in adjacent rows.

FIG. 8 illustrates another embodiment wherein the rows of filaments 32 in second layer 30 comprise discrete portions 33, 35, 37, 39 that are spaced from each other in the direction of the rows. In this embodiment, the rows 32 are substantially parallel to each other, but staggered such that the discrete portions of each row 32 are not aligned with the discrete portions in adjacent rows.

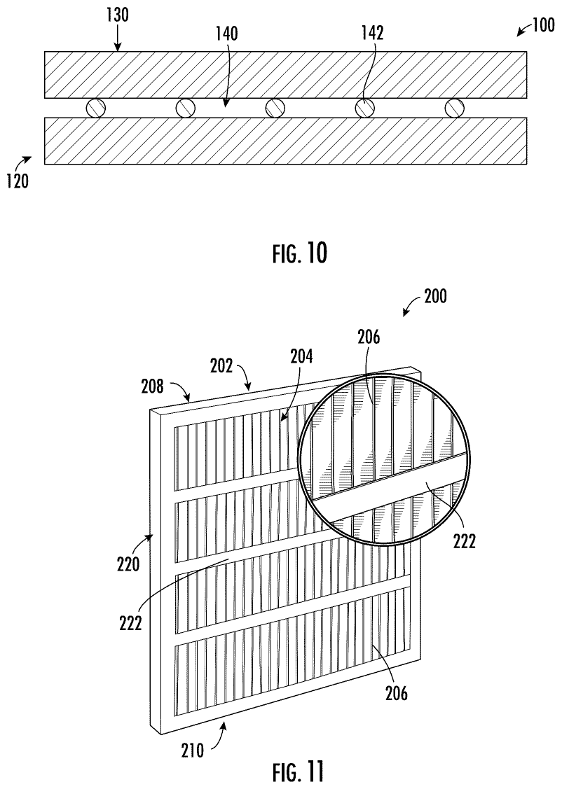

FIG. 9 illustrates another embodiment wherein the rows of filaments 32 in second layer 30 comprise discrete portions 33, 35, 37, 39 that are spaced from each other in the direction of the rows 32. In this embodiment, the rows 32 are not parallel with each other and generally extend in directions that are transverse to each other. The discrete portions in each row may be aligned with, or staggered, relative to the discrete portions in adjacent rows. '

FIG. 10 illustrates another embodiment of a nonwoven material 100 that comprises first and second fiber layers 120, 130 and a third layer of filaments 140 disposed therebetween. The third layer of filaments 140 comprises two or more rows 142 of filaments in contact with each of the first and second fiber layers 120, 130. The rows 412 of layer 140 may have any suitable configuration as described above.

In some embodiments, the first and/or or second layers may compromise additives, such as antibacterial and/or antiviral compositions such as silver, zinc, copper, organosilicone, tributyl tin, organic compounds that contain chlorine, bromine, or fluorine compounds.

In certain embodiments, the first and/or second layers may be electrostatically charged such that, for example, contaminants are captured both with mechanical and electrostatic filtration. The fibers and/or filaments can be electrostatically charged using triboelectric methods, corona discharge, electrostatic fiber spinning, hydro charging, charging bars or other known methods. Corona charging is suitable for charging monopolymer fiber or fiber blend, or fabrics. Tribocharging may be suitable for charging fibers with dissimilar electronegativity. The electrostatic or electret fibers may comprise high loft triboelectric filter media made by carding and needling. Electrostatic fiber spinning combines the charging of the polymer and the spinning of the fibers as a one-step process. One suitable method for triboelectric charging is described in U.S. Pat. No. 9,074,301, the entire disclosure of which is hereby incorporated by reference herein for all purposes.

In certain embodiments, the fibers and/or filaments may include a silicone-based coating to improve the efficiency of the filter media at capturing contaminants, particularly contaminants in the E2 and E3 particle group range. The silicone-based coating may comprise a reactive silicone macroemulsion. The silicone emulsion may comprise, for example, dimethyl silicone emulsions, amino type silicone emulsions, organo-functional silicone emulsions, resin type silicone emulsions, film-forming silicone emulsions, or the like. In one embodiment, the reactive silicone macroemulsion comprises an amino functional polydimethylsiloxane and/or a polyethylene glycol monotridecyl ether. Suitable silicone coatings are described in commonly assigned U.S. patent application Ser. No. 18/464,484, filed Sep. 11, 2023 and U.S. Provisional Patent Application Ser. No. 63/560,813, filed Mar. 4, 2024, the complete disclosure of which is incorporated herein by reference.

The filtration media may comprise a charge additive to modify the triboelectric charge of the fibers and increase the stability and/or duration of the triboelectric charge in the filter. This increases the overall filtration efficiency of the filter without compromising other important characteristics of the filters, such as longevity, dust holding capacity, and the pressure drop or air flow through the filter. Suitable charge additives for triboelectric charging are described in commonly assigned Provisional Patent Application Ser. No. 63/410,731, filed Sep. 28, 2022, the entire disclosures of which are hereby incorporated by reference herein for all purposes.

In certain embodiments, the nonwoven materials discussed herein may be included as part of a filter device that traps or absorbs contaminants, such as a liquid filter, a gas filter for home and commercial air filtration (e.g., HVAC), a surgical mask, or other face covering or the like. The filter device may be a mechanical filter, absorption filter, sequestration filter, ion exchange filter, reverse osmosis filter, surface filter, depth filter or the like, and may be designed to remove many different types of contaminants from the air, water, or others.

In some embodiments, the filter media may be scored, pleated, or folded into a pleated filter. The pleats may be formed by various conventional pleating operations that include, but are not limited to, bar, rotary, and star gear pleating operations.

Referring now to FIG. 11, a self-supporting air filter 200 according to one embodiment generally comprises an outer frame 202 and a filter media 204. Filter media 204 comprises a plurality of pleats 206 extending in a substantially linear direction from a first end 208 of frame 202 to a second end 210. Frame 202 may comprise any standard frame used in self-supporting air filters, such as a HEPA filter, and generally includes an outer support 220 that surrounds filter media 204 and a plurality of horizontal support bars 222 that extend across filter media 204. Frame 202 may be suitable coupled to filter media 204 with conventional adhesives.

The pleats 206 in filter media 204 are self-supporting, meaning that filter media 204 does not include a metal wire backing to hold the shape of the pleats. These filters are more environmentally friendly because do not contain metal and thus are fully incinerable.

Conventional home and commercial air filters, such as the HEPA, pleated filter 200 shown in FIG. 11, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values in depending on particle sizes within the air stream during testing. E3, E2 and E1 values refer to particulate efficiency at 3-10 microns, 1-3 microns, and 0.3 to 1 micron, respectively.

The MERV rating of the filter media discussed herein will vary based on many factors, including the types and sizes of fibers used in the filter media, the width of the filter media, the number and size of pleats (if any), and the like. Likewise, the pressure drop across the filter media will also depend on many factors, including those mentioned above.

In certain embodiments, the filter media described herein may be used to manufacture self-supported, pleated air or HVAC filters with at least a minimum efficiency rating (MERV) of about MERV 5 or about MERV 8 according to ASHRAE 52.2. In some embodiments, the MERV rating is MERV 9, or MERV 10.

Other types of filters that may be developed with the nonwoven material disclosed herein include conical filter cartridges, square end cap filter cartridges, pocket filters, V-bank compact filters, panel filters, flat cell filters, pleated or unpleated bag cartridge filters, and the like.

In an alternative embodiment, the filter may also include nanoparticles incorporated into the substrate or filter media. As used herein, the term “nanoparticle” means any particle that has a dimension less than 20 microns in at least one axis or dimension, or less than 1 micron. The nanofibers may have a continuous length, or the nanofibers may have discrete length, such as 1 to 100,000 microns, preferably between about 100 to 10,000 microns.

In certain embodiments, the nanoparticles are dispersed “in depth” within the substrate. As used herein, the term “in depth” means that the nanoparticles are dispersed beyond a first surface of the substrate such that at least some of the nanoparticles are disposed between first and second opposing surfaces into the internal structure of the substrate or media. In certain embodiments, the nanoparticles are dispersed throughout substantially the entire media from the first surface to the opposing second surface. In other embodiments, the nanoparticles are dispersed through a portion of the media from the first surface to a location between the first and second surfaces.

The nanoparticles can be chosen with different triboelectric properties relative to the first or second fibers in order to use a triboelectric effect to enhance particle removal. With this method, the generated nanoparticles are formed in an electrical field and are less subject to contamination by chemicals that may moderate the triboelectric effect. Nanoparticles with different adsorption properties or surface charge characteristics than the coarse fibers can also be used, e.g. in oil or water filtration. This difference can be used to enhance or create localized electrical field gradients within the filter media to enhance particle removal. The nanoparticles and coarse fibers may have different wetting characteristics.

The nanoparticles may comprise any suitable material, such as glass, biosoluble glass, ceramic materials, acrylic, carbon, metal, such as alumina, polymers (such as nylon, polyethylene terephalate, and the like), polyvinyl chloride (PVC), polyolefin, polyacetal, polyester, cellulous ether, polyalkylene sulfide, poly (arylene oxide), polysulfone, modified polysulfone polymers and polyvinyl alcohol, polyamide, polystyrene, polyacrylonitrile, polyvinylidene chloride, polymethyl methacrylate, polyvinylidene fluoride and any combination thereof.

In some embodiments, the nanoparticles are bonded to the fibers via mechanical entanglement. This mechanical bond can be supplemented with an adhesive or binding agent. In certain embodiments, the nanoparticles are not crimped (i.e., they do not include significant wavy, bent, curled, coiled sawtooth or similar shape associated with the nanoparticle in a relaxed state. In other embodiments, the nanoparticles may have a crimped body structure with a discrete length. For instance, when these crimped nanofibers having a discrete length are attached to the fiber, they entangle among themselves and also with, onto, and around, the fiber with a firm attachment to form a modified fiber. In other embodiments, the attachment of the nanofibers to the micron fibers is accomplished via electrostatic charge attraction and/or Van der Waals force attraction between the fibers and the nanoparticles. A more complete description of filter media incorporating nanoparticles can be found in commonly assigned, co-pending U.S. patent applications having Ser. Nos. 18/297,187, 18/297,188, 18/297,194, 18/297,198, 18/297,203, 18/297,209, 18/297,217, 18/297,223, 18/297,226, 18/297,232, 18/297,239 and 18,297,247 all filed Apr. 7, 2023, the complete disclosures of which are incorporated herein by reference in its entirety for all purposes.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a nonwoven material comprising: a first fiber layer and a second layer in contact with the first layer. The second layer comprises two or more rows of filaments spaced from each other and extending along at least a portion of the first layer.

A second embodiment is the first embodiment, wherein the first fiber layer comprises one or more pleats extending in a first direction and the rows of filaments in the second layer extend in a second direction transverse to the first direction.

A third embodiment is any combination of the first two embodiments, wherein the second direction defines an angle of about 80 degrees to about 100 degrees relative to the first direction.

A 4^{th} embodiment is any combination of the first 3 embodiments, wherein the second direction is substantially perpendicular to the first direction.

A 5^{th} embodiment is any combination of the first 5 embodiments, wherein the first fiber layer comprises a first outer surface and a second outer surface opposite the first surface, wherein the second layer is in contact with the first outer surface.

A 6^{th} embodiment is any combination of the first 5 embodiments, wherein a surface area of the second layer is less than about 50% of a surface area of the first fiber layer.

A 7^{th} embodiment is any combination of the first 6 embodiments, wherein a surface area of the second layer is less than about 40% of a surface area of the first fiber layer.

An 8^{th} embodiment is any combination of the first 7 embodiments, wherein the first fiber layer comprises a first end and a second end opposite the first end, wherein each of the rows of filaments in the second layer extends substantially continuously from the first end to the second end.

A 9^{th} embodiment is any combination of the first 8 embodiments, wherein the pleats each define a first side and a second side and each of the rows of filaments in the second layer extends substantially continuously from the first side of the pleats to the second side of the pleats.

A 10^{th} embodiment is any combination of the first 9 embodiments, wherein each of the rows of filaments in the second layer comprise a plurality of discrete portions spaced from each other.

An 11^{th} embodiment is any combination of the first 10 embodiments, wherein the discrete portions define gaps between each of the pleats.

A 12^{th} embodiment is any combination of the first 3 embodiments, wherein the discrete portions are substantially parallel with each other.

A 13^{th} embodiment is any combination of the first 12 embodiments, wherein the discrete portions are staggered relative to each other in a direction transverse to the first direction.

A 14^{th} embodiment is any combination of the first 13 embodiments, wherein the rows of filaments in the second layer each comprise a single strand of fiber.

A 15^{th} embodiment is any combination of the first 14 embodiments, wherein the rows of filaments in the second layer have a maximum dimension of about 0.1 mm to about 5.0 mm.

A 16^{th} embodiment is any combination of the first 15 embodiments, wherein the maximum dimension is about 0.5 mm to about 1.5 mm.

A 17^{th} embodiment is any combination of the first 16 embodiments, wherein the rows of fibers in the second layer are spaced from each other by a distance of about 25 mm to about 125 mm.

An 18^{th} embodiment is any combination of the first 17 embodiments, wherein the distance is about 12 mm to about 40 mm.

A 19^{th} embodiment is any combination of the first 18 embodiments, further comprising two or more rows of filaments in the second layer extending in a second direction, wherein the second direction is transverse to the first direction.

A 20^{th} embodiment is any combination of the first 19 embodiments, wherein the second direction is substantially perpendicular to the first direction.

A 21^{st} embodiment is any combination of the first 20 embodiments, wherein the second layer is bonded to the first fiber layer.

A 22^{nd} embodiment is any combination of the first 21 embodiments, wherein the second layer is thermally bonded to the first fiber layer.

A 23^{rd} embodiment is any combination of the first 22 embodiments, wherein the second layer is printed onto the first fiber layer.

A 24^{th} embodiment is any combination of the first 23 embodiments, wherein the first fiber layer comprises multicomponent fibers.

A 25^{th} embodiment is any combination of the first 24 embodiments, wherein the first fiber layer comprises biocomponent fibers having a core and a sheath, wherein the core comprises a different material than the sheath.

A 26^{th} embodiment is any combination of the first 25 embodiments, wherein a melting temperature of the sheath is within about 15 degrees Celsius of the melting temperature of the filaments in the second layer.

A 27^{th} embodiment is any combination of the first 26 embodiments, wherein a melting temperature of the sheath is within about 5 degrees Celsius of the melting temperature of the filaments in the second layer.

A 28^{th} embodiment is any combination of the first 27 embodiments, wherein the filaments in the second layer comprise a material selected from the group consisting of polylactic acid (PLA), polyethylene terephthalate (PET), polypropylene (PP), polyester, coPET, polypropylene, polycaprolactam, polyamides, such as polyamide 6 (PA 6), polyamide 6-6 (PA 6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

A 29^{th} embodiment is any combination of the first 28 embodiments, wherein the filaments in the second layer comprise a recycled material.

In another aspect, a filter media is provided comprising the nonwoven material of any of the above 29 embodiments.

In another aspect, a gas filter product comprising the nonwoven material of any of the above 29 embodiments.

In another aspect, a first embodiment is an air filter product for use in a heating, ventilation, and air conditioning (HVAC) system comprising the nonwoven material of any of the above 29 embodiments.

A second embodiment is the first embodiment, further comprising a filter media with one or more pleats.

A third embodiment is any combination of the first two embodiments, wherein the pleats are self-supporting and the filter media is devoid of metal.

In another aspect, a first embodiment is a self-supporting filter media comprising a first fiber layer comprising one or more pleats extending in a first direction and a second layer in contact with the first layer. The second layer comprises two or more rows of filaments spaced from each other and extending in a second direction transverse to the first direction.

A second embodiment is the first embodiment, wherein the first direction defines an angle of about 80 degrees to about 100 degrees relative to the second direction.

A third embodiment is any combination of the first two embodiments, wherein the first direction is substantially perpendicular to the second direction.

A 4^{th} embodiment is any combination of the first 3 embodiments, wherein the first fiber layer comprises a first outer surface and a second outer surface opposite the first surface, wherein the second layer is in contact with the first outer surface.

A 5^{th} embodiment is any combination of the first 5 embodiments, wherein the first outer surface is an outflow side of the filter media.

A 6^{th} embodiment is any combination of the first 5 embodiments, wherein a surface area of the second layer is less than about 50% of a surface area of the first fiber layer.

A 7^{th} embodiment is any combination of the first 6 embodiments, wherein a surface area of the second layer is less than about 40% of a surface area of the first fiber layer.

An 8^{th} embodiment is any combination of the first 7 embodiments, wherein the first fiber layer comprises a first end and a second end opposite the first end, wherein each of the rows of filaments in the second layer extends substantially continuously from the first end to the second end.

A 9^{th} embodiment is any combination of the first 8 embodiments, wherein the pleats each define a first side and a second side and each of the rows of filaments in the second layer extends substantially continuously from the first side of the pleats to the second side of the pleats.

A 10^{th} embodiment is any combination of the first 9 embodiments, wherein each of the rows of filaments in the second layer comprise a plurality of discrete portions spaced from each other.

An 11^{th} embodiment is any combination of the first 10 embodiments, wherein the discrete portions define gaps between each of the pleats.

A 12^{th} embodiment is any combination of the first 11 embodiments, wherein the discrete portions are substantially parallel with each other.

A 13^{th} embodiment is any combination of the first 12 embodiments, wherein the discrete portions are staggered relative to each other in a direction transverse to the first direction.

A 14^{th} embodiment is any combination of the first 13 embodiments, wherein the rows of filaments in the second layer each comprise a single strand of fiber.

A 15^{th} embodiment is any combination of the first 14 embodiments, wherein the rows of filaments in the second layer have a maximum dimension of about 0.1 mm to about 5.0 mm.

A 16^{th} embodiment is any combination of the first 15 embodiments, wherein the maximum dimension is about 0.5 mm to about 1.5 mm.

A 17^{th} embodiment is any combination of the first 16 embodiments, wherein the rows of filaments in the second layer are spaced from each other by a distance of about 25 mm to about 125 mm.

An 18^{th} embodiment is any combination of the first 17 embodiments, wherein the distance is about 12 mm to about 40 mm.

A 19^{th} embodiment is any combination of the first 18 embodiments, wherein the second layer comprises two or more rows of filaments extending in a second direction, wherein the second direction is transverse to the first direction.

A 20^{th} embodiment is any combination of the first 19 embodiments, wherein the second direction is substantially perpendicular to the first direction.

A 21^{st} embodiment is any combination of the first 20 embodiments, wherein the second layer is bonded to the first fiber layer.

A 22^{nd} embodiment is any combination of the first 21 embodiments, wherein the second layer is thermally bonded to the first fiber layer.

A 23^{rd} embodiment is any combination of the first 22 embodiments, wherein the second layer is printed onto the first fiber layer.

A 24^{th} embodiment is any combination of the first 23 embodiments, wherein the first fiber layer comprises multicomponent fibers.

A 25^{th} embodiment is any combination of the first 24 embodiments, wherein the first fiber layer comprises biocomponent fibers having a core and a sheath, wherein the core comprises a different material than the sheath.

A 26^{th} embodiment is any combination of the first 25 embodiments, wherein a melting temperature of the sheath is within about 15 degrees Celsius of the melting temperature of the filaments.

A 27^{th} embodiment is any combination of the first 26 embodiments, wherein a melting temperature of the sheath is within about 5 degrees Celsius of the melting temperature of the filaments

A 28^{th} embodiment is any combination of the first 27 embodiments, wherein the second layer comprises a material selected from the group consisting of polylactic acid (PLA), polyethylene terephthalate (PET), polypropylene (PP), polyester, coPET, polypropylene, polycaprolactam, polyamides, such as polyamide 6 (PA 6), polyamide 6-6 (PA 6-6), co-polyamides, polyesters, polyethylene, high density polyethylene (HDPE), polycarbonate, polyacrylate, polyacrylonitrile, polystyrene, styrene maleic anhydride, propylene, polyimide, polyether ketone, cellulose ester, polyamide, polylactic acid, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

A 29^{th} embodiment is any combination of the first 28 embodiments, wherein the second layer comprises a recycled material.

A 30^{th} embodiment is any combination of the first 29 embodiments, wherein the filter media is devoid of metal.

What is claimed is:

1. A nonwoven material comprising:
a first fiber layer; and
a second layer in contact with the first fiber layer, the second layer comprising two or more rows of filaments spaced from each other and extending along at least a portion of the first fiber layer.

2. The material of claim 1, wherein the first fiber layer comprises one or more pleats extending in a first direction and the rows of filaments in the second layer extend in a second direction transverse to the first direction, wherein the second direction defines an angle of about 80 degrees to about 100 degrees relative to the first direction.

3. The material of claim 1, wherein the first fiber layer comprises a first outer surface and a second outer surface opposite the first surface, wherein the second layer is in contact with the first outer surface.

4. The material of claim 1, wherein a surface area of the second layer is less than about 50% of a surface area of the first fiber layer.

5. The material of claim 1, wherein a surface area of the second layer is between about 50% and about 20% of a surface area of the first fiber layer.

6. The material of 1, wherein the first fiber layer comprises a first end and a second end opposite the first end, wherein each of the rows of filaments in the second layer extends substantially continuously from the first end to the second end.

7. The material of claim 2, wherein the pleats each define a first side and a second side and each of the rows of filaments in the second layer extends substantially continuously from the first side of the pleats to the second side of the pleats.

8. The material of claim 2, wherein each of the rows of filaments in the second layer comprise a plurality of discrete portions spaced from each other.

9. The material of claim 8, wherein the discrete portions define gaps between each of the pleats.

10. The material of claim 8, wherein the discrete portions are substantially parallel with each other.

11. The material of claim 8, wherein the discrete portions are staggered relative to each other in a direction transverse to the first direction.

12. The material of claim 1, wherein the rows of filaments in the second layer are spaced from each other by a distance of about 25 mm to about 125 mm.

13. The material of claim 12, wherein the distance is between about 50 mm to about 80 mm.

14. The material of claim 1, further comprising two or more filaments of fibers in the second layer extending in a second direction, wherein the second direction is transverse to the first direction.

15. A self-supporting filter media comprising:
a first fiber layer comprising one or more pleats extending in a first direction; and
a second layer in contact with the first layer, the second layer comprising two or more rows of filaments spaced from each other and extending in a second direction transverse to the first direction.

16. The filter media of claim 15, wherein the first direction defines an angle of about 80 degrees to about 100 degrees relative to the second direction.

17. The filter media of claim 15, wherein the first outer surface is an upstream side of the filter media.

18. The filter media of claim 15, wherein a surface area of the second layer is less than about 50% of a surface area of the first fiber layer.

19. The filter media of claim 15, wherein a surface area of the second layer is between about 50% and about 25% of a surface area of the first fiber layer.

20. The filter media of claim 15, wherein the rows of filaments in the second layer are spaced from each other by a distance of about 25 mm to about 125 mm.

21. The filter media of claim 20, wherein the distance is about 50 mm to about 80 mm.

22. The filter media of claim 15, wherein the second layer comprises two or more rows of filaments extending in a second direction, wherein the second direction is transverse to the first direction.
